(19) United States
(12) Patent Application Publication
(10) Pub. No.: US 2022/0411239 A1
(43) Pub. Date: Dec. 29, 2022

(54) COLLISION PREVENTION SYSTEM FOR LIFTING MACHINERY

(71) Applicant: SCIENTEC TECHNOLOGY PTE LTD, Singapore (SG)

(72) Inventor: Meng Fei LIM, Singapore (SG)

(73) Assignee: SCIENTEC TECHNOLOGY PTE LTD, Singapore (SG)

(21) Appl. No.: 17/774,544

(22) PCT Filed: Nov. 4, 2020
(86) PCT No.: PCT/SG2020/050633

§ 371 Date: May 5, 2022

(30) Foreign Application Priority Data
Nov. 6, 2019 (SG) 10201910363R

(51) Int. Cl. B66C 15/04; B66C 23/88; B66C 15/06

(52) U.S. Cl. CPC B66C 15/045; B66C 23/88; B66C 15/065

(57) ABSTRACT

A collision prevention system for lifting machinery including, at least one measurement transceiver (9, 39, 41, 45) mountable on or adjacent the lifting machinery, the measurement transceiver being adapted to transmit a radio signal through an operational area surrounding the lifting machinery, and for measuring reflected radio signals returning from the operational area, the reflected radio signals identifying a position of one or more objects located within the operational area to thereby determine whether or not the detected object(s) within the operational area is within a critical position(s) relative to the lifting machinery.

### FIELD

The present invention is generally directed to safety systems for lifting machinery such as cranes, excavators and forklifts, and in particular to a collision prevention system for such lifting machinery.

### BACKGROUND

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Safety issues are always a concern for workers located within the working perimeter of lifting machinery such as tower and mobile cranes, excavators and forklifts. For example, in the case of tower cranes used on building sites, there is an ongoing safety concern due to the potential of the lifting hook block or other part of the crane colliding with workers within the working perimeter of that crane.

While collision prevention systems have been developed for cranes, these systems are focused on the prevention of crane to crane collisions, and for crane to predefined static areas/objects collision. There is therefore a need for a collision prevention system that can prevent collisions between lifting equipment and workers working within the working perimeter of that lifting machinery.

In US20150161872A1 (Trimble), a system has been described that requires a RTLS transceiver mounted on a crane to communicate with RTLS tags worn by each worker within the working perimeter of the crane. The distance between the crane and each worker can then be determined, and the operator of the crane and worker alerted when the distance is too close. This system requires that each worker must wear a RTLS tag while on site which may not always be practical in practice. Furthermore, this system does not provide any collision prevention protection for workers or other persons not wearing a RTLS tag that are on-site. In addition, it is not possible to prevent collisions with inanimate objects located within the working perimeter of the crane with this system unless a RTLS tag is also secured to that object.

An object of the invention is to ameliorate one or more of the above-mentioned difficulties.

### SUMMARY

According to an aspect of the present disclosure, there is provided a collision prevention system for lifting machinery including, at least one measurement transceiver mountable on or adjacent the lifting machinery, the measurement transceiver being adapted to transmit a radio signal through an operational area surrounding the lifting machinery, and for measuring reflected radio signals returning from the operational area, the reflected radio signals identifying a position of one or more objects located within the operational area to thereby determine whether or not the detected object(s) within the operational area is within a critical position(s) relative to the lifting machinery.

In some embodiments, the critical position(s) may be when a calculated distance of the detected object(s) positioned within the operational area is below a predetermined value.

In some embodiments, the system may include a controller module for controlling transmissions of the or each measurement transceiver, and for receiving position data of the detected object(s).

In some embodiments, the controller module may include a warning device for providing a warning to an operator of the lifting machinery when the detected object(s) within the operational area is within the critical position(s).

In some embodiments, the controller module may automatically intervene to slow and/or limit movement of the lifting machinery when the detected object(s) within the operational area is within the critical position(s).

In some embodiments, the system may differentiate between the detected object(s) by identifying movement of the detected object(s).

In some embodiments, the system may include an accelerometer and/or gyro for sensing movement of the or each measurement transceiver to thereby offset said movement when identifying the position of the detected object(s).

In some embodiments, the system may further include an identification device carried by humans authorised to be present within the operational area.

In some embodiments, the system may issue a warning signal to the identification device carried by a said human is detected within the operational area that has be determined to be at a said critical position.

In some embodiments, the system may identify humans not carrying a said identification device as being unauthorised to be within the operational area.

In some embodiments, a warning signal may be provided to the operator of the lifting machinery and to other humans carrying an identification device if unauthorised humans are detected.

In some embodiments, the lifting machinery may be a tower crane, and a said measurement transceiver may be mountable on or adjacent a lifting hook block of the tower crane, the critical position being determined by the distance between the lifting hook block and the detected object(s).

In some embodiments, the lifting machinery may be a mobile crane, and a said measurement transceiver may be mountable on or adjacent a lifting hook block, boom and/or ,counterweight and/or front of an operator's cabin of the mobile crane, the critical position being determined by the distance between the lifting hook block, boom, and/or counterweight and/or front of an operator's cabin and the detected object(s).

In some embodiments, the lifting machinery may be a rail mounted crane, and a said measurement transceiver may be mountable on or adjacent a boogie and/or lifting hook block of the rail mounted crane, the critical position being determined by the distance between the boogie and/or lifting hook block and the detected object(s).

In some embodiments, the lifting machinery may be an excavator, and a said measurement transceiver may be mountable or adjacent on a bucket, hook, arm, back and/or front of an operator's cabin of the excavator, the critical position being determined by the distance between the bucket, hook, arm, back and/or front of an operator's cabin and the detected object(s).

In some embodiments, the lifting machinery may be a forklift, and a said measurement transceiver may be mountable on or adjacent a lifting fork, and/or back and/or front of an operator's cabin of the forklift, the critical position being determined by the distance between the lifting fork, and/or back and/or front of an operator's cabin and the detected object(s).

According to another aspect of the present disclosure, there is provided a method of controlling a collision prevention system for lifting machinery as described above, including;
a) requesting the or each measurement transceiver to transmit a radio signal through the operational area;
b) identifying positional data of at least one detected object within the operational area using the or each measurement transceiver measuring radio signals reflected from the detected object(s); and
c) determining an appropriate action based on the positional data.

In some embodiments, the appropriate action may be to provide a warning signal when the positional data shows the detected object(s) to be in the critical position.

In some embodiments, the warning signal may be provided for an operator of the lifting equipment and/or to authorised humans within the operational area.

In some embodiments, the appropriate action may be to intervene in the operation of the lifting machinery to thereby slow and/or limit movement of the lifting machinery when the positional data shows the detected object(s) to be in the critical position.

Other aspects and features will become apparent to those of ordinary skill in the art upon review of the following description of specific embodiments in conjunction with the accompanying figures.

### BRIEF DESCRIPTION OF THE DRAWINGS

In the figures, which illustrate, by way of example only, embodiments of the present invention,

FIG. 1 is a block diagram of an example collision prevention system for tower and mobile cranes;

FIG. 2 is a block diagram of an example collision prevention system for rail mounted cranes;

FIG. 3 is a block diagram of an example collision prevention system for mobile cranes;

FIG. 4 is a block diagram of an example collision prevention system for excavators and forklifts; and

FIG. 5 is a flow diagram of an example method of controlling a collision prevention system in accordance with an embodiment.

### DETAILED DESCRIPTION

Throughout this specification, unless otherwise indicated to the contrary, the terms “comprising”, “consisting of”, “having” and the like, are to be construed as non-exhaustive, or in other words, as meaning “including, but not limited to”.

Furthermore, throughout the specification, unless the context requires otherwise, the word “include” or variations such as “includes” or “including” will be understood to imply the inclusion of a stated integer or group of integers but not the exclusion of any other integer or group of integers.

The term ‘lifting machinery’ is used in the specification to generally refer to machinery designed to lift objects or for excavation and can therefore include within its scope, but is not limited to, saddle jib and luffing jib tower cranes, boogie mounted tower cranes, telescopic and lattice boom mobile cranes, excavators and forklifts.

The present invention is directed to a collision prevention system and method for lifting machinery, and is specifically directed to preventing human and other objects from contacting or colliding with lifting machinery while located within an operational area surrounding that lifting machinery. The operational area is encompassed by the working perimeter of the lifting machinery.

In an example embodiment, the collision prevention system may include one or more radio transceiver modules together with a controller module for controlling the operation of the radio transceiver modules. The radio transceiver modules can be mounted on or adjacent one or more specific locations on the lifting machinery depending on the type of lifting machinery that the collision prevention system is being used on. The controller module may also be mounted on the lifting machinery, for example within the control cabin of the operator of the lifting machinery. It is however also envisaged that the controller module be located remote from the lifting machinery.

The or each radio transceiver module of the collision prevention system according to the present disclosure operates by periodically transmitting radio signals throughout at least a substantial portion of the operational area of the lifting machinery upon which the measurement transceiver is mounted. The measurement transceiver then measures any reflected radio signals returning from the operational area, the reflected radio signals identifying the position of any object detected within the operational area. The distance between the measurement transceiver and the detected object can therefore can be determined. Furthermore, the detected object can be differentiated by detecting any movement of the object indicated by the reflected radio signals. Any object having movement, such as body, limb or breathing movement, can be considered a human, or a moving object, while non-moving objects can be considered inanimate objects such as buildings, scaffoldings and stationary machineries. Accelerometers or gyros may be included within the radio transceiver module to offset, for example, any movement of the lifting machinery upon which the radio transceiver module is mounted, and thereby ensure that the position of the detected object, and distance between the radio transceiver module and the detected object is correctly determined.

Humans that are authorized to be present within the operational area can optionally be required to carry or wear an identification device such as a mobile phone, smart watch, or radio transmitting device. The identification device can be detected by the collision prevention system to identify the human as being part of the working crew and authorized to be within the operational area. It is noted that the identification device is not used to determine the distance between the radio transceiver module and the human carrying the identification device in the present disclosure. Rather, that device is primarily used to identify the wearer of that device.

The positional data and object differentiation data can then be transmitted to the controller module which can then if necessary, take an appropriate action. For example, the controller may activate a warning device such as a red light or buzzer if a detected object such as a human is determined to be at a critical position, for example, at a distance below a predetermined value from the measurement transceiver and are therefore are at risk. The warning intensity may also progressively increase as the human/object gets closer. A warning signal may also be optionally provided if an unauthorized human is detected within the operational area. The controller module can also automatically intervene in the operation of the lifting machinery by showing slowing and/or limiting of the movement of the machinery when a detected object is determined to be too close to the location on the lifting machinery where the radio transceiver module is positioned.

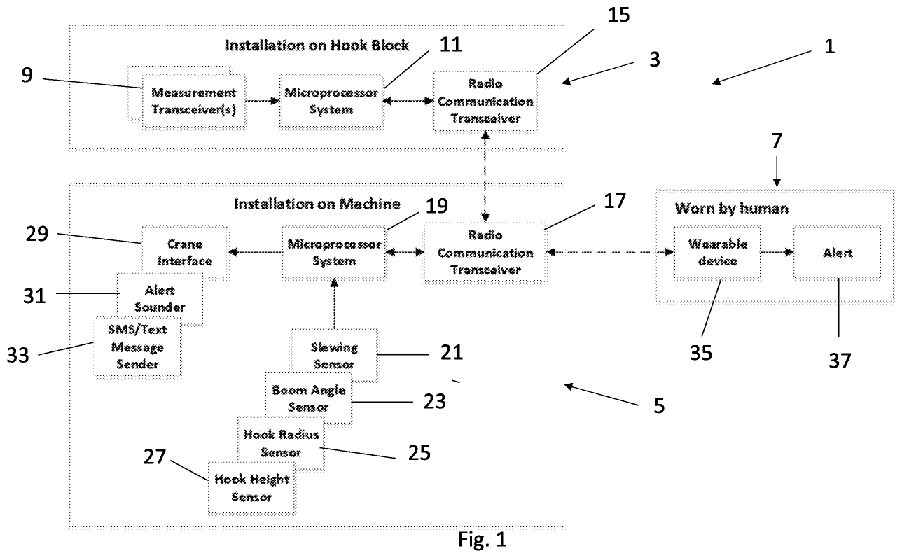

FIG. 1 shows a collision prevention system 1 according to the present disclosure applicable for tower or mobile cranes. The system 1 comprises a radio transceiver module 3 which can be mounted on the lifting hook block of the crane. The radio transceiver module 3 is mounted on or adjacent this location as human collisions are most likely to occur with the lifting hook block during operation of a tower crane. It is not as necessary to mount a radio transceiver module 3 on the boom\jib of the tower crane as they are positioned much higher than humans during operation of the tower crane, and therefore unlikely to collide with any human or other object. Each radio transceiver module 3 comprises one or more measurement transceivers 9, a microprocessor system 11, and a radio communication transceiver 15. Radio signals can be periodically transmitted from the measurement transceiver 9, any reflected radio signal may be measured by the measurement transceiver 9. The microprocessor system 11 can run detection algorithms to detect objects and their position, and differentiate the objects into humans and other inanimate objects depending on whether or not any movement is detected.

The controller module 5 comprises a radio communication transceiver 17 that communicates with the radio communication transceiver 15 of the radio transceiver module 3. The control module radio communication transceiver 17 can periodically request the radio transceiver module 3 to perform a detection cycle to measure the position of detected objects or humans, and can receive the resultant positional and differentiation data from radio transceiver module 3. The received data can be processed by a controller module microprocessor system 19 which is also fed with information on the position of the crane boom and hook respectively from a slewing sensor 21, boom angle sensor 23, hook radius sensor 25, and hook height sensor 27. These sensors 27 derive the position and orientation of different parts of the crane relative to each other. This positional information can be used in conjunction with the information obtained from the radio transceiver module 3 to determine the level of risk of collision with a human or other object. The level of risk can be determined by identifying whether or not the detected object is in a critical position relative to the lifting machinery. The critical position can be when the calculated distance of the detected object positioned within the operational area is within a predetermined value.

The controller module microprocessor system 19 can display the positional information via a crane interface 29 that can for example be mounted within the cabin of the operator, as well as determining the appropriate response to the data provided by the radio transceiver module 3. This may include providing a warning signal from an alert sounder 31 as required. The controller module radio communication transceiver 17 can also be in communication with an identification device 35 worn by human authorized to work within the operational area of the crane. That device 35, as well identifying the human, also allows for an alert 37, to be received from a SMS\text message sender 33 controlled by the microprocessor system 19 of the controller module 5.

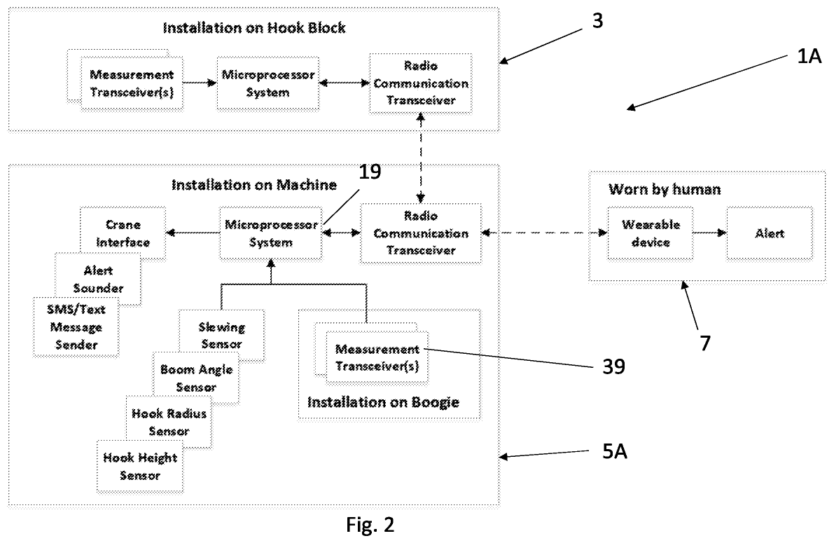

In the case of mobile cranes mounted on wheels or tracks, radio transceiver modules or individual measurement transducers can also be mounted on other parts of the crane including the boogie, boom and main body of the crane. This is because these parts of a mobile crane can also potentially contact a human or other object during travelling movement of the crane, lowering of the boom and during slewing of the crane. FIG. 2 shows the collision prevention system 1A according to another embodiment of the present disclosure applicable for rail mounted cranes. Such cranes are mounted on a wheeled boogie that can run on the rails. The collision prevention system 1A is almost identical to the system 1 shown in FIG. 1 in having a radio transceiver module 3 mounted on the lifting hook block. However, measurement transceivers 39 can also be mounted on the boogie for providing additional information of the positional and differentiation data of detected objects near the boogie to the controller module microprocessor system 19.

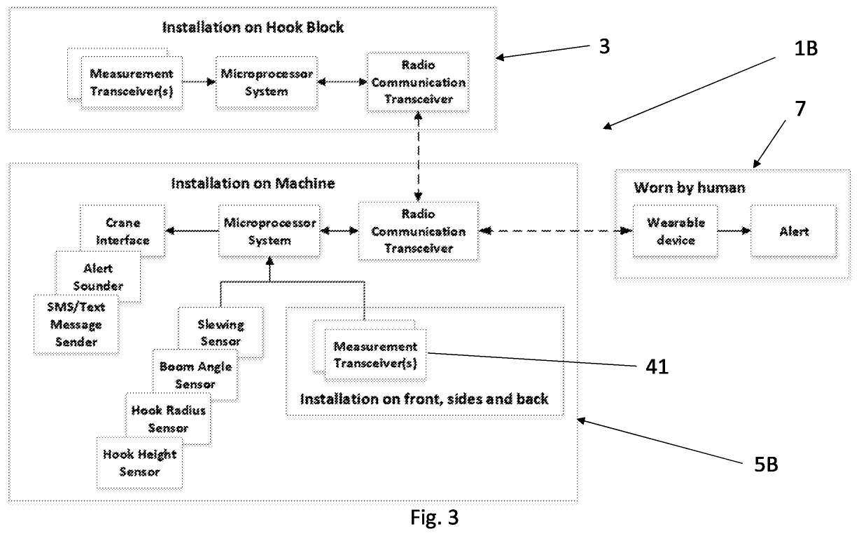

FIG. 3 shows a collision prevention system 1B according to another embodiment of the present disclosure suitable for mobile cranes such as telescopic and lattice boom mobile cranes. This embodiment differs from the embodiment shown in FIG. 2 in that measurement transceivers 41 can also be mounted on the front, sides, and back of the mobile crane in addition to on the lifting hook block. These transceivers 41 provide additional positional information on objects detected near the main body of the mobile crane.

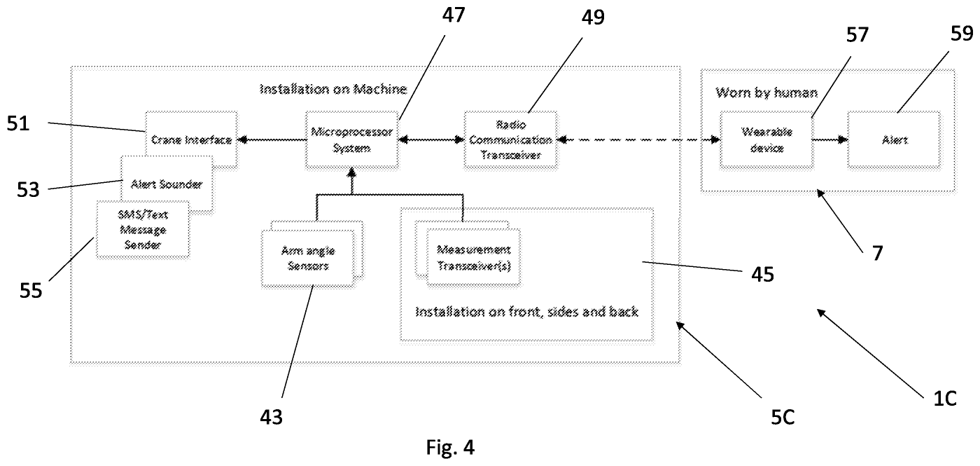

FIG. 4 shows another embodiment of a collision prevention system 1C according to the present disclosure, suitable for excavators and forklifts. This system 1C has less components than the earlier described embodiments in having a combined radio transceiver/controller module 5C. This module 5C has a measurement transceiver 45 for transmitting radio signals through the operational area, and a radio communication transceiver 49 for detecting and for communicating with identification devices 7 worn by authorised humans. The radio transceiver/controller module 5C also has an arm angle sensor 43 providing data on the position of the arm/fork to the microprocessor system 47 of the module 5C. Separate measurement transceivers 45 may be provided on the front, back and sides of the lifting equipment as required for measuring reflected radio signals from objects to thereby provide positional data of detected objects to the microprocessor system 47 of the controller module 5C. The radio communication transceiver 48 can also issue an alert 59 for the identification device 7 when necessary. Furthermore, the collision prevention system 1C also comprises a crane interface 51, alert sounder 53 and SMS/Text sender 55 controlled by the microprocessor system 47 similar to the embodiments shown in FIGS. 1 to 3.

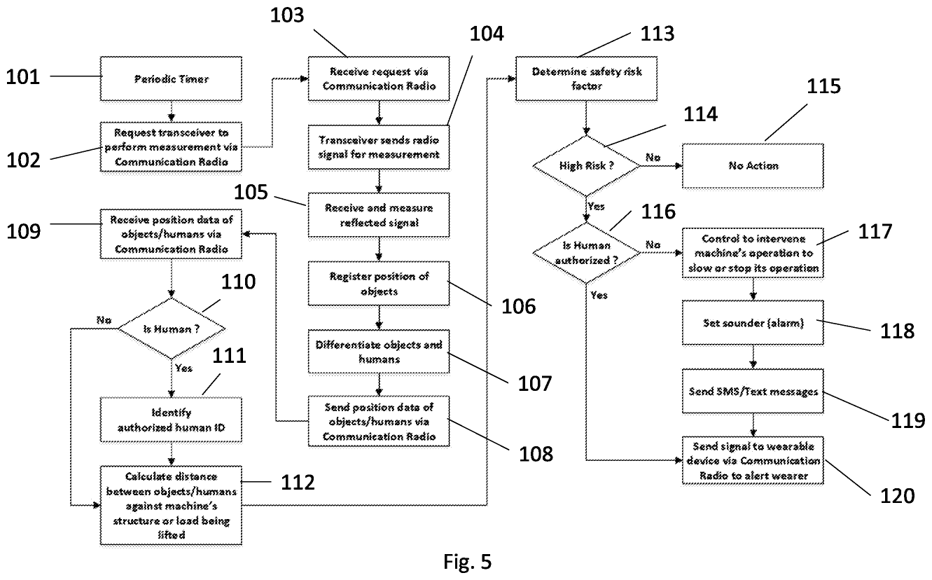

FIG. 5 is a flow diagram showing the method of controlling a collision prevention system according to an embodiment of the present disclosure. The controller module includes a periodic timer (Step 101) that periodically sends a request (Step 102) to the measurement transceiver of the radio transceiver module requesting that a measurement be performed via communication radio (Step 103). Following receipt of the request (Step 103), the measurement transceiver sends a radio signal through the operational area surrounding the crane (Step 104). Any returning reflecting radio signals are received (Step 105) and measured to which registered the position of any detected object (Step 107). The microprocessor system of the radio transceiver module further differentiates the detected objects between human and other inanimate objects (Step 107) before sending the positional data of the detected human and other objects via communication radio to the controller module (Step 108). The received positional data (Step 109) is then separately vetted depending on whether or not the object is human (Step 110). If any human is detected, a radio or other signal is initially sent to the detected human who may be wearing an identification device to identify whether they are authorised to be in the operational area (Step 111). The positional data of all detected humans and objects are then processed to calculate the distance between the detected object and the one or more measurement transceivers located on the lifting hook block and/or structure of the lifting machinery (Step 112). The safety risk factor is then determined (Step 113) depending on whether or not the distance is below a predetermined value (Step 114). If no risk is determined, no further action is taken (Step 115). Otherwise, if high risk is determined (Step 114), then the method can conduct different actions depending whether or not the detected human is authorized to be in the operational area or not (Step 116). If the human is authorized, then a warning signal can be sent to the identification device worn by the human to warn them that they are at risk (Step 120). If the human is not authorized, the controller module can automatically intervene in the operational of the lifting machinery by slowing or stopping its operation (Step 117). A warning alarm can also be emitted to warn the unauthorized human (Step 118). An SMS or other text message can be sent to that human (Step 119) in case they have a mobile phone or watch that can receive such messages (Step 120).

Unless defined otherwise, all technical and scientific terms used herein have the same meaning as is commonly understood by a skilled person to which the subject matter herein belongs.

It should be appreciated by the person skilled in the art that the above invention is not limited to the embodiment described. It is appreciable that modifications and improvements may be made without departing from the scope of the present invention.

It should be further appreciated by the person skilled in the art that one or more of the above modifications or improvements, not being mutually exclusive, may be further combined to form yet further embodiments of the present invention.

1. A collision prevention system for lifting machinery including, at least one measurement transceiver mountable on or adjacent the lifting machinery, the measurement transceiver being adapted to transmit a radio signal through an operational area surrounding the lifting machinery, and for measuring reflected radio signals returning from the operational area, the reflected radio signals identifying a relative position of one or more objects located within the operational area to thereby determine whether or not the detected object(s) within the operational area is within a critical position(s) relative to the lifting machinery, wherein a said measurement transceiver is at least mountable on a lifting hook block of the lifting machinery, and wherein the system includes an accelerometer and/or gyro mountable with the said measurement transceiver for sensing movement of the said measurement transceiver to thereby offset said movement when identifying the relative position of the detected object(s).

2. The collision prevention system for lifting machinery according to claim 1, wherein the critical position(s) is when a calculated distance of the detected object(s) positioned within the operational area is below a predetermined value.

3. The collision prevention system for lifting machinery according to claim 1, wherein the system includes a controller module for controlling transmissions of the or each measurement transceiver, and for receiving position data of the detected object(s).

4. The collision prevention system for lifting machinery according to claim 3, wherein the controller module includes a warning device for providing a warning to an operator of the lifting machinery when the detected object(s) within the operational area is within the critical position(s).

5. The collision prevention system for lifting machinery according to claim 3, wherein the controller module automatically intervenes to slow and/or limit movement of the lifting machinery when the detected object(s) within the operational area is within the critical position(s).

6. The collision prevention system for lifting machinery according to claim 1, wherein the system differentiates between the detected object(s) by identifying movement of the detected object(s).

7. The collision prevention system for lifting machinery according to claim 1, wherein the system further includes an identification device carried by humans authorised to be present within the operational area.

8. The collision prevention system for lifting machinery according to claim 7, wherein the system issues a warning signal to the identification device carried by a said human is detected within the operational area that has be determined to be at a said critical position.

9. The collision prevention system for lifting machinery according to claim 7, wherein the system identifies humans not carrying a said identification device as being unauthorised to be within the operational area.

10. The collision prevention system for lifting machinery according to claim 9, wherein a warning signal is provided to the operator of the lifting machinery and to other humans carrying an identification device if unauthorised humans are detected.

11. The collision prevention system for lifting machinery according to claim 1, wherein the lifting machinery is a tower crane having a said lifting hook block, and a said measurement transceiver is mountable on or adjacent the lifting hook block of the tower crane, the critical position being determined by the distance between the lifting hook block and the detected object(s).

12. The collision prevention system for lifting machinery according to claim 1, wherein the lifting machinery is a mobile crane having a said lifting hook block, and a said measurement transceiver is mountable on or adjacent the lifting hook block, and a boom ,counterweight and/or front of an operator's cabin of the mobile crane, the critical position being determined by the distance between the lifting hook block, boom, counterweight and/or front of an operator's cabin and the detected object(s).

13. The collision prevention system for lifting machinery according to claim 1, wherein the lifting machinery is a rail mounted crane having a said lifting hook block, and a said measurement transceiver is mountable on or adjacent the said lifting hook block, and a boogie of the rail mounted crane, the critical position being determined by the distance between the boogie and/or lifting hook block and the detected object(s).

14. A method of controlling a collision prevention system for lifting machinery as claimed in claim 1, including;
a) requesting the or each measurement transceiver to transmit a radio signal through the operational area;
b) identifying positional data of at least one detected object within the operational area using the or each measurement transceiver measuring radio signals reflected from the detected object(s); and
c) determining an appropriate action based on the positional data.

15. The method according to claim 14, wherein the appropriate action is to provide a warning signal when the positional data shows the detected object(s) to be in the critical position.

16. The method according claim 15, wherein the warning signal is provided for an operator of the lifting equipment and/or to authorised humans within the operational area.

17. The method according to claim 14, wherein the appropriate action is to intervene in the operation of the lifting machinery to thereby slow and/or limit movement of the lifting machinery when the positional data shows the detected object(s) to be in the critical position.
